(19) United States
(12) Patent Application Publication
(10) Pub. No.: US 2026/0089638 A1
(43) Pub. Date: Mar. 26, 2026

(54) METHOD FOR CONFIGURATION OF WAKE-UP SIGNALING IN A RADIO NETWORK

(71) Applicant: Sony Group Corporation, Tokyo (JP)

(72) Inventors: Nafiseh Seyed MAZLOUM, Lund (SE); Anders BERGGREN, Lund (SE); Basuki PRIYANTO, Lund (SE); Torgny PALENIUS, Barsebäck (SE)

(21) Appl. No.: 19/111,719

(22) PCT Filed: Aug. 17, 2023
(86) PCT No.: PCT/EP2023/072719

§ 371 Date: Mar. 13, 2025

(30) Foreign Application Priority Data
Sep. 30, 2022 (SE) 2251140-6

(51) Int. Cl. H04W 52/02

(52) U.S. Cl. CPC H04W 52/0235

(57) ABSTRACT

A method carried out in a network node of a cellular radio network for configuring a User Equipment, UE, to monitor wake-up signal, WUS, reception in non-connected mode, wherein the method comprises: obtaining (500) information related to the UE, said information being indicative of a wake-up receiver, WUR, being comprised in the UE, and indicative of associated timing performance of the WUR; configuring (502) the UE with WUR configuration, based on the obtained information, said WUR configuration identifying resources for monitoring WUS reception at WUR Active times repeated with a WUR cycle, wherein the WUR cycle is configured without being restricted to a paging occasion, PO, cycle.

### TECHNICAL FIELD

This disclosure relates to methods and devices in a wireless communication system, adapted to control communication between a wireless network and a wireless terminal. Specifically, solutions are provided for configuration of a low power receiver for wake-up signal detection in non-connected mode, inter alia for triggering the terminal to activate a main receiver for subsequent communication with the wireless network.

### BACKGROUND

In radio communication systems, such as various generations provided through the 3rd Generation Partnership Project (3GPP), various specifications have been provided for setting up common rules for setting up and operating both a wireless radio interface between a wireless terminal and a network node, and various levels of operation of the network. In 3GPP documentation, a wireless terminal is commonly referred to as User Equipment (UE), a term that will be used throughout this disclosure. Such UEs are connectable to a core network by means of a radio access network RAN, which includes one or more network nodes, operative to provide radio access to UEs within a cell. Such network nodes may also be referred to as an access node or a base station, and various terms are used in 3GPP for different types of systems or specifications. In the so-called 4G specifications, also referred to as Long-Term Evolution (LTE), the term eNodeB (eNB) is used to denote a network node. Further systems beyond 4G network include New Radio (NR), developed to support 5G RAN. 5G RAN is able to operate both in connection to a 4G Core network (EPC), or a 5G core network 5GC. A network node configured to operate in a 5G radio access network may be denoted a gNB.

Energy efficiency is a key design requirement for UEs with limited energy resource, e.g., UEs using small rechargeable and single coin cell batteries. Among use cases, sensors and actuators may be deployed extensively for more or less non-complex tasks, such as monitoring, measuring, charging, etc. Such UEs may e.g. be configured as wearables, including smart watches, eHealth related devices, and medical monitoring devices. Generally, batteries for such UEs are not rechargeable, but shall be expected to last at least few years, as described in 3GPP TR 38.875. This is a challenging task.

Currently, UEs can be configured with discontinuous reception scheme (DRX) in a non-connected mode, such as idle or inactive mode, where the UE periodically wake up once per DRX cycle to reduce the cost of channel listening. Legacy type DRX configuration for use in non-connected mode may be operated for monitoring paging occasions (PO), and is therefore occasionally referred to herein as PO monitoring DRX configuration. Such DRX configuration is characterized by a DRX Active time, for monitoring PO, repeated with a DRX cycle. Prior to DRX Active time, there is a preparation stage where the UE perform synchronization. Subsequently, the UE needs to operate the main receiver to perform control channel decoding during DRX Active time. There is a trade-off between UE power consumption and UE availability in time. In scenarios where the UEs need to be available within a certain time limit, the DRX cycles needs to be relatively short. This, however, results in high power consumption at the UE as the UE needs to listen to the channel even when there is no signaling or data traffic, in order to be prepared for potential paging message.

Already in Release 15, 3GPP introduced provisions for wake-up signaling for machine-type communication (MTC) protocols appropriate for low-complexity UEs. MWUS (MTC Wake-Up Signal) allows the UE to save energy for the purpose of paging monitoring. Rather than to decode the paging channel data for determining if a paging request is received, a wake-up signal was specified to indicate a valid page in the next PO (Paging Occasion) to the UE. Configuration of a window for WUS monitoring is defined based on a time offset with respect to a DRX configuration. In Release 16 and 17 of NR 3GPP signaling similar to MWUS was introduced to IDLE/INACTIVE and CONNECTED mode.

Use of an ultra-low power wake-up receiver in a UE, in addition to its main receiver, can reduce the cost of its channel listening significantly. A dedicated low-power receiver, in a form of ultra-low power wake-up receiver, operating based on discontinuous reception can further reduce the cost of channel listening. While operation of a low-power receiver is known, challenges exist with regard to integration of such operation into existing NR 3GPP schemes, such as DRX schemes.

### SUMMARY

In view of the mentioned ongoing development in wireless communication and associated challenges, various solutions for determining the time offset are provided herein, and as set out in the independent claims.

A method carried out in a network node of a cellular radio network for configuring a User Equipment, UE, to monitor wake-up signal, WUS, reception in non-connected mode, wherein the method comprises:
obtaining information related to the UE, said information being indicative of a wake-up receiver, WUR, being comprised in the UE, and indicative of associated timing performance of the WUR;
negotiating, with the UE, WUR configuration determined dependent on the obtained information, identifying resources for use in the UE to monitor WUS reception at WUR Active times repeated with a WUR cycle.

Contrary to legacy procedures, timing for monitoring of WUS is specifically configured for use by the low-power WUR, rather than simply being tied to paging occasion, PO, time configuration by a time offset. The WUR cycle is thus configured without being restricted to a paging PO monitoring DRX cycle.

The proposed method provides increased flexibility for the network to arrange for wake-up signaling, and enhanced energy conservation in UEs, for different applications. Specifically, long battery life in the UE may be obtained while achieving short response time, i.e. enabling low latency requirements. This may e.g. be obtained by providing dedicated WUR configuration for use by a WUR, where the WUR cycle is substantially shorter than what can be obtained with legacy DRX, targeting the same or longer battery lifetime.

Further details and advantageous effects are set out in the full claim set and in the following description.

### BRIEF DESCRIPTION OF THE DRAWINGS

Various embodiments will be described with reference to the drawings, in which

FIG. 1 schematically illustrates a wireless communication system providing for communication between an access node of a wireless network and a UE.

FIG. 2 schematically illustrates a UE configured to operate according to various embodiments outlined herein.

FIG. 3 schematically illustrates a network node configured to operate according to various embodiments outlined herein.

FIG. 4 schematically illustrates the general concept according to the state of the art of wake-up signaling prior to a DRX Active time window of a legacy DRX configuration for monitoring PO.

FIG. 5 shows a flow chart comprising various steps that may be included in a method carried out by a network node according to various embodiments.

FIG. 6 shows a flow chart comprising various steps that may be included in a method carried out by a UE according to various embodiments.

FIG. 7A illustrates a signaling diagram according to a first general embodiment of the proposed solution, where PO monitoring DRX is disabled.

FIG. 7B shows various actions and events over time in one example of the first general embodiment of the proposed solution, where DRX is disabled.

FIG. 8A illustrates a signaling diagram according to a second general embodiment of the proposed solution, operating in combination with a PO monitoring DRX configuration.

FIG. 8B. shows various actions and events over time in one example of the second general embodiment of the proposed solution

### DETAILED DESCRIPTION

The invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, when an element is referred to as being “connected” to another element, it can be directly connected to the other element or intervening elements may be present. In contrast, when an element is referred to as being “directly connected” to another element, there are no intervening elements present. Like numbers refer to like elements throughout. It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

Well-known functions or constructions may not be described in detail for brevity and/or clarity. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

Embodiments of the invention are described herein with reference to schematic illustrations of idealized embodiments of the invention. As such, variations from the shapes and relative sizes of the illustrations as a result, for example, of manufacturing techniques and/or tolerances, are to be expected. Thus, embodiments of the invention should not be construed as limited to the particular shapes and relative sizes of regions illustrated herein but are to include deviations in shapes and/or relative sizes that result, for example, from different operational constraints and/or from manufacturing constraints. Thus, the elements illustrated in the figures are schematic in nature and their shapes are not intended to illustrate the actual shape of a region of a device and are not intended to limit the scope of the invention.

Various embodiments are outlined herein, generally suitable for employment in a 3GPP radio communication system, such as NR, but any type of wireless communication system operating with a wake-up signal usable for activating a reception window may employ the suggested solutions. For this reason, the term UE will generally be used to denote a wireless device connectable by e.g. radio communication with a wireless network, and the term access node or base station will be used to denote a node of the wireless network configured to provide wireless access to UEs within a certain cell or coverage area.

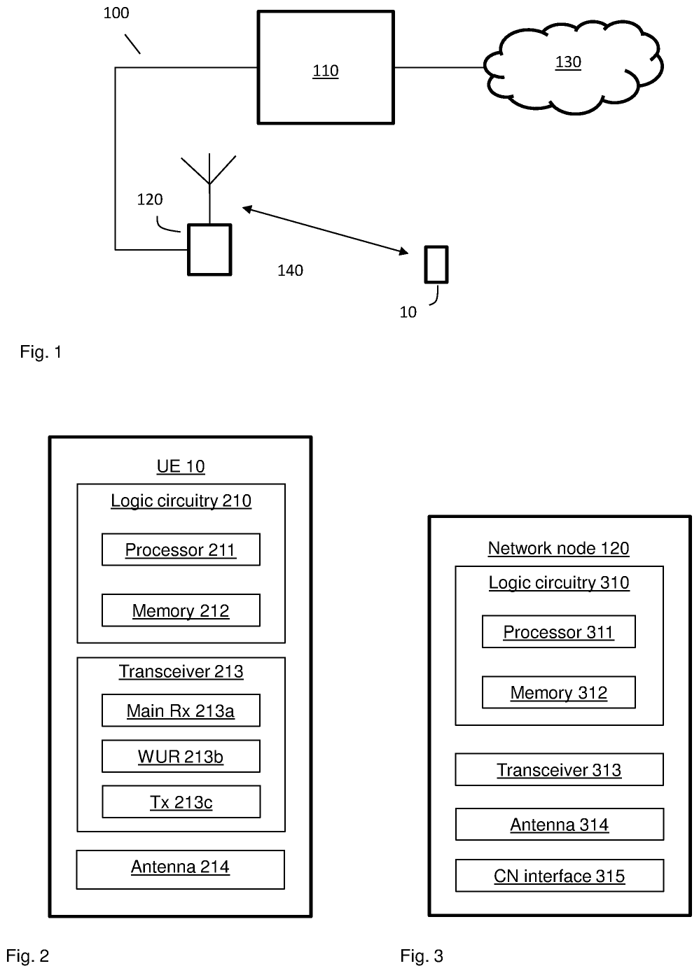

FIG. 1 schematically illustrates a wireless communication system including a wireless network 100, and a UE 10 configured to wirelessly receive radio signals from the wireless network 100. The wireless network may be a radio communication network operating under general and specific regulations and limits published by the 3GPP, such as a New Radio (NR) network. The wireless network 100 may include a core network 110, which is connected to other networks 130, such as the Internet. The wireless network 100 further includes an access network, such as a RAN, which may comprise a plurality of access nodes, of which access node 120 is shown. An access node is an entity executing the wireless connection with wireless UEs 10. As such, the access node 120 comprises or is connected to a transmission point TRP including an antenna arrangement for transmitting and receiving radio signals. The access node 120 may also be referred to as a base station, and may be a gNB. A gNB consists of one or more Transmission and Reception Points (TRP).

The wireless UE 10 may be any device operable to wirelessly communicate with the network 100 through the radio access node 120, such as a mobile telephone, computer, tablet, a M2M device or other. In the embodiments outlined herein, the UE is capable of operating or idling in non-connected mode, such as idle mode or inactive mode (where user context is preserved in the CN 110).

FIG. 2 schematically illustrates an embodiment of the UE 10 for use in a wireless network 100 as presented herein, and for carrying out the method steps as outlined.

The UE 10 may comprise a radio transceiver 213 for communicating with other entities of the radio communication network 100, such as the access node 120. The transceiver 213 may thus include a main receiver 213a and a transmitter 213c for communicating by radio over an air interface. The UE 10 is further configured with a separate low-power receiver 213b, operable for detecting e.g. a WUS, in addition to the main receiver 213a. The low-power receiver 213b is referred to herein Wake-Up Receiver (WUR) but may optionally be called LP-WuRx or a low-power wake-up radio. In some embodiments, the receiver function 213b need not be a separate receiver, but rather a configuration of the main receiver 213a for reduced function or operation.

The UE 10 may further comprise an antenna system 214, which may include one or more antennas, antenna ports or antenna arrays. The antenna system 214 is connected to the transceiver for wireless communication of radio signals.

The UE 10 further comprises logic circuitry 210 configured to communicate data and control signals, via the radio transceiver 213, on a physical channel 140 with the wireless communication network 100.

The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

Obviously, the UE 10 may include other features and elements than those shown in the drawing or described herein, such as a power supply, a casing, a user interface, sensors, etc., but these are left out for the sake of simplicity.

FIG. 3 schematically illustrates a radio node in the form of an access node 120 of the wireless network 100 as presented herein, and for carrying out the method steps as outlined. In various embodiments, the access node 120 is a base station for operation in the radio communication network 100, to serve one or more UEs, such as the UE 10.

The access node 120 may comprise a wireless transceiver 313, such as a radio transceiver for communicating with other entities of the radio communication network 100, such as the terminal 10. The transceiver 313 may thus include a radio receiver and transmitter for communicating through at least an air interface.

The access node 120 further comprises logic circuitry 310 configured to control the access node 120 to communicate with the UE 10 via the radio transceiver 313 on a physical channel 150.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the access node 120 to carry out any of the method steps as provided herein. Software defined by said computer program code may include an application or a program that provides a function and/or a process. The software may include device firmware, an operating system (OS), or a variety of applications that may execute in the logic 310.

The access node 120 may further comprise, or be connected to, an antenna 314, which may include an antenna array. The logic 310 may further be configured to control the radio transceiver to employ an anisotropic sensitivity profile of the antenna array to transmit radio signals in a particular transmit direction. The access node 120 may further comprise an interface 315, configured for communication with the core network 110. Obviously, the access node 120 may include other features and elements than those shown in the drawing or described herein, such as a power supply and a casing etc.

As noted, DRX operation of UEs has been in effect for a long time. For non-connected UEs, which may refer to RRC_Idle or RRC_Inactive, PO monitoring DRX configuration (commonly referred to as idle mode DRX) provides a DRX cycle which is identical to the paging cycle. At each DRX Active time, the UE wakes up and synchronizes to decode a channel to determine if paging has been transmitted for the UE. If paging is detected, the UE may proceed according to legacy behavior to connect to the transmitting radio network node. If not, the UE deactivates monitoring and returns to sleep for a DRX cycle.

Further development of 3GPP specifications has taken place to target inter alia UE energy (battery) conservation. This includes e.g. the concept of Paging Early Indication (PEI), where a UE is notified in advance of its Paging Occasion (PO), whether the UE has to monitor the PO. As a result of this, UE can skip the time-frequency synchronization prior to a PO, if the UE need not monitor the PO. The PEI can be signaled via a Downlink Control Information (DCI) message carried in the Physical Downlink Control Channel. The PEI may further carry sub-grouping information to divide the UEs, sharing the same Paging Occasion, into sub-groups. This results in lower group paging rate and fewer false paging alarms. In PEI, UEs are notified in advance of each PO.

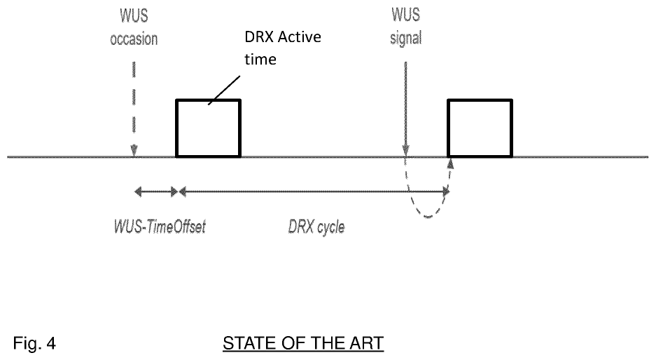

As described earlier, another known effort to target energy conservation is the implementation of WUS. This is indicated by way of example in FIG. 4. In 3GPP Release 15, especially for MTC and NB-IoT UE, a wake-up signal (WUS) sent over the physical resources that “wakes up” a UE from an idle state so that it can prepare to receive data was first introduced. Known as the wake-up signal (WUS), this feature reduces power consumption and improves battery life by dramatically reducing a device's resource draw. Again, as indicated in FIG. 4, the WUS is monitored before each PO, i.e. each DRX Active time. Specifically, the WUS is monitored prior to each DRX Active time, according to a configured time offset determined based on the DRX Active time.

In order to further target UE energy consumption issues, use of a low-power WUR in the UE, instead of the main receiver, has been suggested. The proposed solution is intended for such a device configuration of the UE, as illustrated in FIG. 2.

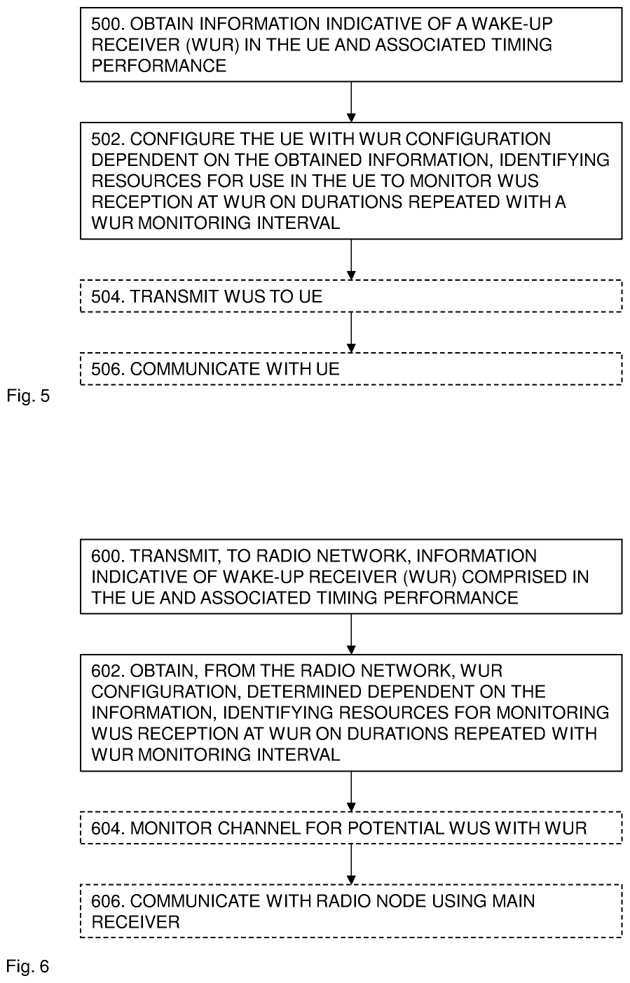

FIG. 5 shows a flow chart of the proposed invention, as carried out in a cellular radio network. The method may be operated by a radio node in the form of a base station, or gNB for a 5G implementation. In other embodiments, different steps of the method may be carried out by a network node comprising distributed nodes, including a base station and a core network node, such as an Access and Mobility Management Function (AMF), which is one of the control plane network functions (NF) of the 5G core network (5GC) 110.

According to one aspect, the method carried out in a network node is provided, for configuring a UE, wherein the method comprises:

Obtaining 500 information indicative of a wake-up receiver, WUR, in the UE 10. The information comprising presence of a WUR, and further data including timing information associated with the WUR, may be obtained as UE radio capability information. The radio network 100 may obtain the UE radio capability information upon the UE registering to the network 100, according to legacy procedures. A network node configured as an access node 120 may obtain the UE radio capability information from the core network 110, or from another access node, or directly from the UE 10.

The information indicative of the wake-up receiver may comprise or identify information associated with decoding capability, latency requirement of the UE 10, data rate of the WUR, timing information related to transitioning time between detection of a signal by the WUR 213b to complete activation of the main receiver 213a in the UE 10, etc.

Configuring 502 the UE with WUR configuration, determined dependent on the obtained information, said WUR configuration identifying resources for use in the UE to monitor WUS reception at WUR Active times repeated with a WUR cycle. Here, the WUR cycle identifies an cycle or cycle of repetition of occasions of WUR Active time, for monitoring WUS reception with the WUR. WUR is in sleep or non-active when it is not in active. Configuring may in this context comprise negotiating with the UE 10. This may involve transmitting one or more WUR configuration parameters as system information by broadcasting, and/or transmitting one or more WUR configuration parameters in one or more Radio Resource Control (RRC) messages. In some embodiments, a complete set of WUR parameters may be transmitted by the radio network 100 for receipt in the UE 10. In this context, certain WUR configuration parameters may be set by a core network node, such as the AMF, and some or all by the radio node 120. In some embodiments, one or more transmitted WUR configuration parameters may enable the UE 10 to calculate or determine further WUR configuration parameters, so as to obtain complete WUR configuration in the UE 10. The configuring may further comprise obtaining uplink confirmation or acknowledgement in the radio node 120 from the UE 10. The full WUR configuration identifies at least timing and frequency parameters for radio resources to monitor, and may further comprise sequence information, power control information, details related to encoding the WUS, etc.

The WUR configuration is determined dependent on the obtained information and specifies a WUR cycle of WUR Active times. Specifically, the WUR cycle may be configured independent of paging occasion, PO, time configuration, in the sense that timing of the WUR Active times is not configured based on paging occasion, PO, timing. As will be outlined in further detail, system operation of wake-up signaling may be operated as a replacement scheme to, or in combination with, legacy PO monitoring DRX configuration.

Step 504 indicates operation according to the WUR configuration being provided according to the proposed solution. Where the network 100 detects a trigger to alert the UE 10 while in non-connected mode, e.g. data being received or created in the radio network for DL communication to the UE 10, one or more radio nodes 120 may transmit a WUS addressing the UE 10. The WUS may be targeting the UE 10 based on use of radio resources identified by the WUR configuration for said UE 10, negotiated at 502.

In step 506, where the WUS is securely received and decoded in the UE 10, the radio node 120 from which the WUS was transmitted may further communicate with the UE 10, in a time window associated with the WUR Active time in which the WUS was transmitted. This may involve transmitting, by the access node 120, a paging signal or a PEI, and further continuing with a RACH (Radio Access Channel) procedure to connect the UE 10 to the network 100, according to legacy behavior.

FIG. 6 shows a flow chart of the proposed invention, as carried out in a UE, and which is more or less complementary to the method of FIG. 5. The method is operated by a UE 10 which comprises a main receiver 213a and in addition a low-power receiver WUR 213b, usable at least for monitoring WUS. Communication according to FIG. 6 is conveyed via a radio node 120.

According to this aspect, a method carried out in the UE 10 is provided, for obtaining configuration for monitoring WUS from a network node 120 of the radio network 100. The method comprises:

Transmitting 600, to the radio network 100, information indicative of a wake-up receiver, WUR, being comprised in the UE, and indicative of associated timing performance of the WUR. As noted with reference to FIG. 5, the information comprising presence of a WUR, and further data associated with the WUR, may be conveyed to the radio network 100 upon registering of the UE 10 to the network 100. In some embodiments, the information may be conveyed by the UE 10 transmitting a capability ID, which may be identified in the radio network 100 to obtain the full UE radio capability information, according to the procedures known as RACS (UE Radio Capability Signaling Optimization). The information indicative of the wake-up receiver may comprise or identify information associated with decoding capability, latency requirement of the UE 10, data rate of the WUR 213b, timing information related to transitioning time between detection of a signal by the WUR 213b to complete activation of the main receiver 213a in the UE 10, etc.

Obtaining 602, from the radio network 100, WUR configuration, determined dependent on the transmitted information, said WUR configuration identifying resources for use in the UE to monitor WUS reception at WUR Active times repeated with a WUR cycle. This may involve receiving one or more WUR configuration parameters transmitted as system information by radio network broadcasting, and/or receiving one or more WUR configuration parameters in one or more Radio Resource Control (RRC) messages. In some embodiments, a complete set of WUR parameters may be received by the radio network 100. In this context, certain WUR configuration parameters may be set by a core network node, such as the AMF, and some or all by the radio node 120. In some embodiments, one or more received WUR configuration parameters may enable the UE 10 to calculate or determine further WUR configuration parameters, so as to obtain complete WUR configuration in the UE 10 upon the obtainment 602. Obtaining may comprise uplink confirmation or acknowledgement to the radio network 100, e.g. radio node 120, from the UE 10. The full WUR configuration identifies at least timing and frequency parameters for radio resources to monitor, and may further comprise sequence information, power control information, details related to encoding the WUS to be received by low-power WUR, etc.

The WUR configuration is thus configured dependent on the transmitted information and specifies a WUR cycle of WUR Active times. Specifically, the WUR cycle is configured independent of paging occasion, PO, time configuration, in the sense that timing of the WUR Active times is not configured based on paging occasion, PO, timing.

Step 604 indicates monitoring the channel for potential WUS transmission using the WUR 213b, based on the obtained WUR configuration. This involves monitoring WUR Active times which are configured independent of PO configuration, and/or with a WUR cycle, which is different than the PO cycle, or without a PO cycle being configured or active. The WUR cycle may be shorter than a configured PO cycle.

Upon detecting a WUS intended for the UE 10, the UE 10 may be configured to perform a subsequent action. This action need not be network-related, and may e.g. convey a trigger for the UE 10 to carry out a task, such as reading a sensor or taking another type of measurement, changing sensing type or direction, storing or deleting data, etc. Upon the UE 10 detecting a WUS during monitoring 604, and the WUS triggers network communication, the UE 10 may proceed to step 606.

In step 606, where the UE 10 has securely received and decoded the WUS, the UE 10 may further communicate with the radio node 120 from which the WUS was received, in a time window associated with the WUR Active time in which the WUS was transmitted. This may involve synchronizing and decoding a control channel to obtain a paging signal or an PEI, preconfigured uplink resources (PUR) and further continuing with a RACH (Radio Access Channel) procedure to connect to the network 100, according to legacy behavior.

The proposed method provides increased flexibility for the network 100 to arrange for wake-up signaling, and enhanced energy conservation in UEs. This is obtained by providing dedicated WUR configuration for use by a low-power WUR, where Active times for monitoring WUS are not configured to or constrained by PO configuration. Rather than being restricted to legacy DRX configurations, where wake-up signaling is tied to POs, the WUR cycle may be independently configured. This allows for a wider scheme of selectable WUR configurations. Moreover, the proposed solution provides for other use of WUS than specifically to initiate paging, such as even actions which are not related or requiring further network communication. In various embodiments and configured settings, the UE may operate the WUR configuration while DRX is disabled, non-configured or non-activated. A time window may be configured, usable for communication or signaling 506, 606 between the radio node 120 and the UE 10, responsive to the radio node 120 transmitting a WUS intended for the UE in a WUR Active time, wherein a starting time of the time window is configured based on the WUR Active time. Such time window may e.g. comprise configuration of a control channel to which the UE can synchronize for decoding a paging occasion or a paging early indicator.

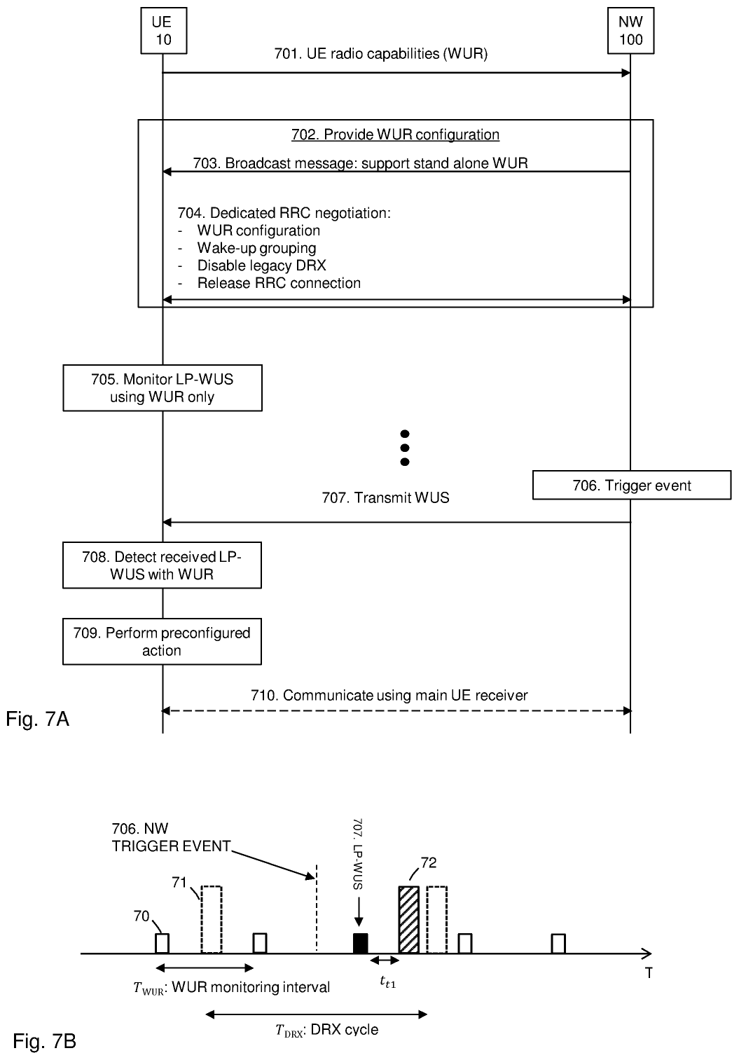

FIGS. 7A and 7B illustrate various aspects of a first general embodiment, wherein WUR configuration is applied in replacement of legacy DRX configuration. In this context, this may comprise not configuring legacy DRX for the UE 10, or disabling configured DRX, or the UE 10 being allowed, by the network 100, to ignore a received DRX configuration. FIG. 7A is a signaling diagram showing signals conveyed between the UE 10 and the radio network (NW) 100. Communication by the network 100 may be carried out by or through the radio node 120. It should be noted, though, that certain communication, such as capability reporting by the UE 10 and broadcasting of information from the network 100, may be carried out via other radio nodes. FIG. 7B is a time diagram, where it shall be noted that vertical extension does not relate to frequency but is used for schematically indicate relative data size or rate that may be conveyed in different configured time windows.

With reference to FIG. 7A, step 701 indicates conveying of information indicative of presence of a WUR 213b in the UE 10. As noted, this step may alternatively comprise the UE 10 indicating its UE radio capability to the network 100 upon registration, and the network node 120 subsequently obtaining the information related to WUR from another network node. This corresponds to steps 500, 600 of the flowcharts. The information may further be indicative of associated timing performance of the WUR. The information may thus comprise or identify latency requirement of the UE 10, data rate of the WUR 213b, timing information related to transitioning time between detection of a signal by the WUR 213b to complete activation of the main receiver 213a in the UE 10, etc. The information may further identify decoding capability of the WUR.

In step 702, the UE 10 is provided with WUR configuration, corresponding to steps 502, 602 of the flowcharts. Complete WUR configuration comprises configuration parameters identifying one or more of a WUR cycle, a WUR Active time for monitoring WUS, a starting point of at least one WUR Active time, radio resources for monitoring WUS and for potentially for acknowledging WUS, configuration identifying a time window subsequent to WUR Active time for carrying out a network task, such as paging, connecting, transmitting data etc. The WUR configuration may further identify details of character of the WUS to monitor, such as power settings, signal repetition or duration, sequence character etc. WUR configuration may further comprise providing an ID to the UE 10, which will be used for targeting the UE 10 upon WUS transmission, e.g. for the purpose of initiating paging. Such ID may be a group ID, which may be used in common for a plurality of UEs. Configuration of a ID or group ID, for WUS monitoring using the WUR, may be carried out by NAS (Non Access Stratum) signaling.

In some embodiments, configuring of the UE 10 may comprise one or more broadcast transmissions 703, from a radio node 120, of a message identifying that the radio node 120 supports standalone WUR operation which is not tied to DRX configuration or PO timing. The broadcast message 703 may fulfill one or more tasks, according to various examples set out below.

In one example, such broadcast message 703 may comprise one or more WUR configuration parameters, or data for allowing the UE 10 determine one or more WUR configuration parameters, as part of providing full WUR configuration to the UE 10. This provides simplified configuration of a plurality of UEs.

In one example, the broadcast message 703 comprises an indicator, such as a specific flag or bit may be set by the radio node 120, identifying disabling of use of PO-based DRX monitoring in non-connected mode. This allows the network 100 to configure UEs to disable legacy DRX operation that has already been configured, e.g. at certain times, for instance when determined by an application which operates with the UE 10, or when deemed suitable by the radio node 120 based on inter alia traffic conditions in the cell. It also allows the radio node 120 to target either a specific UE or group of UEs, by indicating a UE ID or group ID in the broadcast message 703. In one example, the broadcast message 703 may comprise an indicator identifying disabling or not supporting WUR operation.

In some embodiments, negotiation of WUR configuration may comprise providing WUR configuration to the UE 10, such as one or more WUR configuration parameters, in RRC negotiation 704. This may involve providing WUR configuration parameters or information which is sufficient for the UE 10 to obtain full WUR configuration, as described above. When WUR configuration is completed, RRC connection may be released.

Obtainment of full WUR configuration in the UE 10 may thus be carried out either by broadcast message 703 reception, by RRC negotiation 704, or as a combination of the two.

According to some examples, WUR configuration for monitoring WUS, including start of WUR Active time, length of WUR Active time, and WUR cycle, may be characterized as follows.

Start of WUR Active time: The WUR (or LP-WuRx) 213b is assumed to have a coarse synchronization level compared to the main radio receiver 213a. This entails that the WUR 213b may need to start up Tₓ msec earlier than the actual start time of the WUS monitoring occasion to guarantee that the UE 10 is available before the network 100 starts WUS transmission. While the actual value of Tₓ depends on the WUR implementation, a minimum time needs to be included in the calculation.

$${T}_{st}^{WUR} = {T}_{st} - {T}_{x} ,$$

In this context, WUR Active time may be configured by the network 100, taking Tₓ into consideration based on timing performance obtained in capability information. In an alternative example, the WUR configuration may identify the WUR Active time representing the WUS monitoring occasion, wherein the UE 10 determines by itself to start up at least Tₓ earlier.

Tₛₜ represents starting time of WUS monitoring occasion, and can be calculated using similar expression as in section 7, 3GPP TS38.304 but with a difference that T_{WUR}, representing the WUR cycle which replaces T representing the DRX cycle, is determined based on the latency required for LP-WuRx enabled devices, N number of total number of monitoring occasions (MOs) of LP-WuRx, N_s total number MO in a monitoring frame. Since only devices with LP-WuRx capability follow this expression the number of UEs listening to these MO is limited, resulting in limited false-wake-up. To further reduce the number of false wake-up, a further sub-grouping can be used in the content of LP-WUS.

Length of WUR Active time may be determined based on the data rate of the WUR 213b (as identified in the information of the WUR reported by UE radio capability), the number of bits needs to be transmitted in the LP-, including information related to cell-ID, sub-grouping, and improved coverage, as well as an extra margin to allow the radio node 120 for LP-WUS scheduling and transmission.

Length of WUR cycle T_{WUR}, may be determined by taking into account UE latency or reachability in time requirement, as provided as timing performance of the WUR. The WUR cycle also needs to be longer than the WUR Active time.

At step 705 the UE 10 has thus been configured to monitor the channel for potential WUS (also denoted LP-WUS) only using its low-power receiver WUR 213b, in non-connected mode.

At 706, the radio node detects a trigger event. This may e.g. involve receiving, from the core network 110, an indication of availability of data destined for the UE 10. In another example, the trigger event 706 may be a request to obtain UL data from the UE 10. In yet another example, the trigger event 706 may be to obtain an acknowledgment from the UE 10 to indicate its presence in the cell served by the radio node 120.

In step 707 the radio node transmits WUS in accordance with the WUR configuration.

In step 708 the UE 10 receives and decodes the WUS using the WUR 213b.

In step 709, the UE 10 performs a preconfigured action, responsive to detecting the WUS. As noted, this may be an action which is not related to network operation or communication. In some examples, though, the preconfigured action may comprise communication with the radio network 100, through the radio node 120 which transmitted the WUS. In that case, the preconfigured action may comprise activation of the main receiver 213a in the UE 10.

Step 710 indicates such communication, which may include acknowledging the WUS, which may be carried out before or without activating the main receiver 213a. Communication may further comprise initiating RACH procedure to connect to the radio node 120, or potentially to transmit small data during the RACH procedure without fully connecting, an uplink transmission via PUR.

FIG. 7B shows various actions over time, in accordance with an example of signaling steps 705-710 of FIG. 7A. Herein, the shorter boxes indicate WUR Active times 70, i.e. windows according to the WUR configuration for monitoring WUS 705 by the UE 10, and usable for sending 707 WUS by the radio node 120. The WUR Active times are repeated with a WUS DRX cycle, according to the WUR configuration. The tall boxes with dashed contour indicate DRX Active times 71 according to legacy type DRX configuration, with an associated DRX cycle. The dashed contour indicates disabling of any DRX configuration usable for the UE 10. As noted, this may mean that the legacy DRX configuration has never been obtained in the UE 10, or that it has been disabled at least temporarily. The UE 10 is thus not configured to monitor WUS or PO according to the PO-based legacy DRX configuration, i.e. where WUS is monitored before each configured PO.

At 706, a NW trigger event occurs, which may be any one of the examples provided above.

At 707, the radio node 120 transmits a WUS to be received in the configured WUR Active time. The WUS is received and detected 708 in the UE 10 using the WUR 213b, indicated by the corresponding WUR Active time being filled, whereby the UE 10 is triggered to perform 709 the preconfigured action.

The diagram of FIG. 7B illustrates an example of the configured action 709 comprising communication or signaling between the UE 10 and the radio node 120. This may involve activation of the main receiver 213a for further synchronization and decoding to monitor PO or EPI by the UE 10.

In this context, the WUR configuration may comprise, or be associated with, a configured time window 72, usable for a communication action between the network node and the UE responsive to transmitting a WUS 707 intended for the UE 10 in a WUR Active time.

A starting time of the time window 72 may be configured based on the WUR Active time. Configuring of the time window 72 may e.g. comprises configuring a time window starting time based on the WUR configuration, said time window having a starting time offset by a time tₜ₁ after the WUR Active time, as shown. The starting time offset may be configured based on a transition time for activating the main receiver 213a of the UE 10, as determined based on the obtained timing performance of the WUR 213b.

In contrast to legacy behavior, a time window for a communication action, such as a PO, may thus be configured based on the WUR configuration, rather than WUS monitoring taking place at each PO, configured based on the PO timing. The proposed solution provides for improved flexibility in configuring of a UE. By employing the WUR configuration, cycle by the WUR can be configured without being restriction to available DRX configuration.

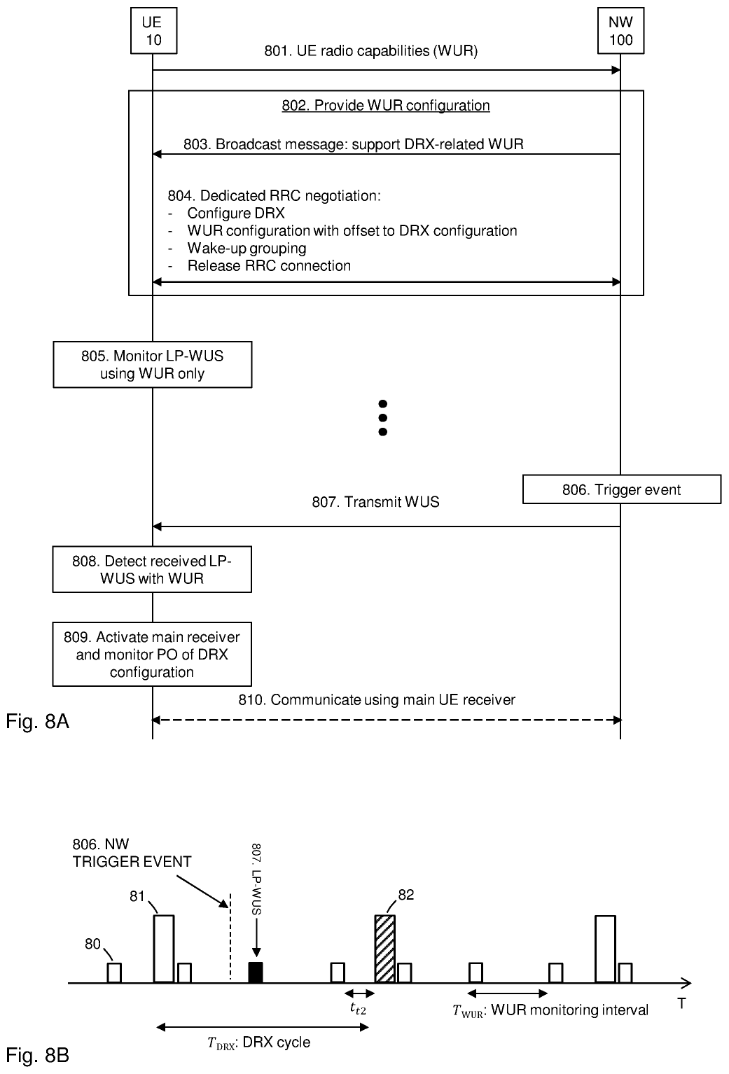

FIGS. 8A and 8B illustrate various aspects of a second general embodiment, wherein WUR configuration is applied in combination with a DRX configuration, such as a legacy DRX configuration. FIG. 8A is a signaling diagram showing signals conveyed between the UE 10 and the radio network 100 through the radio node 120. FIG. 8B is a time diagram, where it shall be noted that vertical extension does not relate to frequency but is used for schematically indicate relative data size or rate that may be conveyed in different configured time windows.

With reference to FIG. 8A, step 801 indicates conveying of information indicative of presence of a WUR 213b in the UE 10. As noted, this step may alternatively comprise the UE 10 indicating its UE radio capability to the network 100 upon registration, and the network node 120 subsequently obtaining the information related to WUR from another network node. This corresponds to steps 500, 600 of the flowcharts. The information may further be indicative of associated timing performance of the WUR. The information may thus comprise or identify latency requirement of the UE 10, data rate of the WUR 213b, timing information related to transitioning time between detection of a signal by the WUR 213b to complete activation of the main receiver 213a in the UE 10, etc. The information may further identify decoding capability of the WUR.

In step 802, the UE 10 is provided with WUR configuration, corresponding to steps 502, 602 of the flowcharts. It may be noted that the UE 10 may in this context already have obtained a DRX configuration, or obtains such DRX configuration in step 802.

Complete WUR configuration comprises configuration parameters identifying one or more of a WUR cycle, a WUR Active time for monitoring WUS, a starting point of at least one WUR Active time, radio resources for monitoring WUS and for potentially for acknowledging WUS. The WUR configuration may identify time correlation or configuration between the WUR configuration and the DRX configuration. This may involve identifying a relation of size, in time, between the WUR cycle and the DRX cycle of the DRX configuration. The time correlation may further be configured such that each WUR Active time precedes a next DRX Active time by a period to at least meeting a required transition time for activating a main receiver or transmitter of the UE. The WUR configuration may further identify details of character of the WUS to monitor, such as power settings, signal repetition or duration, sequence character etc. WUR configuration may further comprise providing an ID to the UE 10, which will be used for targeting the UE 10 upon WUS transmission, e.g. for the purpose of initiating paging. Such ID may be a group ID, which may be used in common for a plurality of UEs.

In some embodiments, providing configuration to the UE 10 may comprise one or more broadcast transmissions 803, from a radio node 120, of a message identifying that the radio node 120 supports DRX-related WUR operation. The broadcast message 803 may fulfill one or more tasks, according to various examples set out below.

In one example, such broadcast message 803 may comprise one or more WUR configuration parameters, or data for allowing the UE 10 determine one or more WUR configuration parameters, as part of providing full WUR configuration to the UE 10. This provides simplified configuration of a plurality of UEs. Broadcast message 803 may further comprise one or more configuration parameters for a DRX configuration.

In one example, the broadcast message 803 comprises an indicator, such as a specific flag or bit set by the radio node 120, identifying enabling or disabling of use of the WUR configuration in non-connected mode. This allows the network 100 to configure UEs to disable WUS monitoring according to legacy DRX operation that has already been configured, i.e. where WUS is monitored by the UE before each DRX Active time. This can be configured e.g. at certain times, for instance when determined by an application which operates with the UE 10, or when deemed suitable by the radio node 120 based on inter alia traffic conditions in the cell. It also allows the radio node 120 to target either a specific UE or group of UEs, by indicating a UE ID or group ID in the broadcast message 803.

In some embodiments, negotiation of WUR configuration may comprise providing WUR configuration to the UE 10, such as one or more WUR configuration parameters, in RRC negotiation 804. This may involve providing WUR configuration parameters or information which is sufficient for the UE 10 to obtain full WUR configuration, as described above. Dedicated communication 804 may further provide configuration parameters for providing a DRX configuration to the UE 10, in addition to or instead of by broadcasting 803.

When WUR configuration and DRX configuration is completed, RRC connection may be released.

Obtainment of full WUR configuration in the UE 10 for use in combination with a DRX configuration may thus be carried out either by broadcast message 803 reception, by RRC negotiation 804, or as a combination of the two.

At step 805 the UE 10 has thus been configured to monitor WUS (also denoted LP-WUS) only using its low-power receiver WUR 213b, in non-connected mode.

At 806, the radio node detects a trigger event. This may e.g. involve receiving, from the core network 110, an indication of availability of data destined for the UE 10. In another example, the trigger event 806 may be a request to obtain UL data from the UE 10. In yet another example, the trigger event 806 may be to obtain an acknowledgment from the UE 10 to indicate its presence in the cell served by the radio node 120.

In step 807 the radio node transmits WUS in accordance with the WUR configuration.

In step 808 the UE 10 receives and decodes the WUS using the WUR 213b.

In step 809, the UE 10 activates the main receiver 213a and proceeds to monitor a PO of the DRX configuration.

Step 810 indicates communication, which may be based on paging detected by the UE 10 using the main receiver 213a. Communication may further comprise initiating RACH procedure to connect to the radio node 120, or potentially to transmit small data during the RACH procedure without fully connecting.

FIG. 8B shows various actions over time, in accordance with an example of signaling steps 805-810 of FIG. 8A. Herein, the shorter boxes indicate WUR Active times 80, i.e. windows according to the WUR configuration for monitoring WUS 805 by the UE 10, and usable for sending 807 WUS by the radio node 120. The WUR Active times are repeated with a WUS cycle, according to the WUR configuration. The tall boxes DRX Active times 81 according to a DRX configuration obtained in the UE 10 for non-connected mode operation. The DRX configuration has an associated DRX cycle between DRX Active times that may be employed for paging purposes. In contrast to legacy procedures, however, WUS transmission is not scheduled based on each DRX Active time 81. Instead, the WUR configuration is applied for monitoring WUS in the UE according to the determined WUR cycle. Based on the detecting WUS reception 807 using the WUR configuration, by the low-power receiver 213b, the UE 10 proceeds to detect paging in the next subsequent DRX Active time 82.

At 806, a network trigger event occurs, based on the network needing to obtain connection with the UE for UL or DL communication.

At 807, the radio node 120 transmits a WUS to be received in the configured WUR Active time. The WUS is received and detected 708 in the UE 10 using the WUR 213b, indicated by the corresponding WUR Active time being filled, whereby the UE 10 is triggered to activate its main receiver 213a to monitor paging in the next DRX Active time 82.

The embodiments outlined with reference to FIGS. 8A and 8B are usable for a UE 10 equipped with a low-power WUR 213b configured with a discontinuous WUS monitoring using a WUR cycle, in relation to legacy DRX operation. In the example of FIG. 8B, time correlation provides that WUR Active times and DRX Active times are time shifted so as not to collide. In an alternative embodiment, the configured time correlation may provide that WUR Active times and DRX Active times occasionally collide, or partly overlap, such as at every n:th WUR Active time. Where this is the case, the UE 10 is configured to turn on the radio that is needed to provide the necessary activity in that time-period. In other words, if the UE 10 has not detected a WUS in a preceding WUR Active time since a last DRX Active time, it will continue to monitor resources for WUS detection using the low-power receiver 213b. If, on the other hand, the UE 10 has detected a WUS in a preceding WUR Active time and not yet monitored for paging, it will activate the main receiver 213a and monitor resources according to the DRX configuration.

The proposed solution provides opportunities for the radio network 100 to schedule WUS transmission whenever it is suitable for the radio network 100, such when triggered by an application. The solution also provides opportunity to sub-group UEs, by configuration 804 of group IDs. UEs may be configured to monitor a certain active WUR Active time for their WUS.

Each sub-group may be differently configured. For example, s group that has short latency may be allocated with shorter WUR cycle, and/or smaller gap between each WUR Active time, in effect longer WUR Active time. The length of WUR Active time may also be configured dependent on the amount of information to signal for different types of WUS

A relation of time alignment between the WUR cycle and the DRX cycle of the DRX configuration may be provided in the configuration 803, 804, and/or a relation of size, in time, of the WUR cycle with respect to the DRX cycle. Time correlation may be configured such that each WUR Active time precedes a next DRX Active time by a configured period tₜ at least meeting a required transition time for activating the main receiver 213a of the UE. This provides a certain offset between each WUR Active time 80 and the subsequent legacy DRX Active time 81. According to one embodiment, the time offset and legacy DRX Active time are calculated based on an expression as a function of UE-ID and number of groups being created for all WUR Active times between the two legacy DRX Active times. This entails that subgrouping may in some examples be performed by time multiplexing the subgroups such that different groups monitor different WUS transmissions. Then the WUS transmissions are scheduled with different WUR Active time occasions before the next legacy DRX Active time. Thus, the time offset to the legacy DRX configuration depends on the number of groups.

According to some examples, WUR configuration, including start of WUR Active time, length of WUR Active time, and WUR cycle (representing total WUR duty-cycle length) may be characterised as follows.

Start of WUR Active time: The start of the WUR Active time may be determined in relation and with a time offset to the upcoming DRX Active time, as described above with respect to time alignment between the WUR cycle and the DRX cycle of the DRX configuration.

Length of WUR Active time may be determined based on inter alia the data rate of the WUR 213b, as described earlier with reference to the examples of FIGS. 7A and 7B.

Length of WUR cycle T_{WUR}, i.e. the total WUR DRX period, may be configured dependent on applied DRX configuration, based on UE latency or reachability in time requirement, as provided as timing performance of the WUR. In this context, the WUR cycle is configured to 1/K times the DRX cycle, K being an integer ≥1. In other words:

$${T}_{WUR} = \frac{{T}_{DRX}}{K}$$

By this arrangement, where the WUR cycle is configured as an integer fraction of the DRX cycle between POs, it is ensured that the WUR Active time preceding the DRX Active time is always configured sufficiently early in order for the UE 10 to activate its main receiver 213a responsive to detecting a WUS in that last WUR Active time. In some examples, K>1. i.e. the proposed solution provides for monitoring and detection of WUS with a higher periodicity than the PO cycle. This allows inter alia, as described, for configuration of UEs with different group IDs to monitor different WUR Active times between POs of succeeding DRX Active times. This increases network flexibility in configuration and accessing of UEs for different purposes and needs. Specifically, it increases the possibility to minimize UE energy consumption and improves the ability of the radio network to balance latency requirements and energy consumption requirements.

According to various examples, the radio network 100 may be configured for dynamic operation to selectively configure UEs in its cell to operate according to any of the embodiments outlined herein. A UE 10 can thus be configured by the network either to operate in a mode of disabling legacy DRX operation, as outlined with reference to FIGS. 7A and 7B, or to operate in a co-existence mode of legacy DRX and specifically configured WUR monitoring, as outlined with reference to FIGS. 8A and 8B. Such operation can be UE specific or cell specific. The operation mode may be indicated by the network 100 in SIB (System Information Bit) or by unicast signaling, including activation and/or deactivation of the mode.

In an alternative embodiment, the UE 10 is arranged to determine or decide the operation mode and by itself, for example, depending signal strength, such as on DL-RSRP (Reference Signal Received Power). According to one example, the following rule applies:

If the RSRP is good, i.e. meets a certain evaluation criterion such as above certain threshold, the UE can use either of the two modes, dependent on which is configured for the UE.

If the RSRP is bad, e.g. below a certain threshold, then the UE can disable the operation of WUR configuration and fall back to the legacy operation according to a DRX configuration.

The network 100 may broadcast required threshold values for the UE 10 use to determine to activation/deactivation the usage of WUR configuration.

Various aspects of the proposed solution have been outlined in the foregoing. Different features and functions of such aspects may be combined in any way or form where not contradictory, and in accordance with the claims set out below.

1. A method carried out in a network node of a cellular radio network for configuring a User Equipment (UE) to monitor wake-up signal (WUS) reception in non-connected mode, wherein the method comprises:
obtaining information related to the UE, said information being indicative of a wake-up receiver (WUR) being comprised in the UE, and indicative of associated
timing performance of the WUR;
configuring the UE with WUR configuration, based on the obtained information, said WUR configuration identifying resources to monitor for WUS reception at WUR Active times repeated with a WUR cycle,
wherein the WUR cycle is configured without being restricted to a paging occasion (PO) cycle.

2. The method of claim 1, wherein the WUR cycle is shorter than a discontinuous reception (DRX) cycle configurable by the network node for the UE.

3. The method of claim 1, wherein the WUR cycle is independent of any discontinuous reception (DRX) cycle configurable by the network node for the UE.

4. The method of claim 1, wherein the WUR configuration defines WUR Active time length, based on data rate of the WUR identified by said information.

5. The method of claim 1, wherein said information indicative of presence of the WUR is obtained as UE radio capability information for said UE.

6. The method of claim 1, wherein the WUR configuration identifies a group ID to monitor by the UE in a received WUS, wherein said group ID is determined based on WUR type or ID of said information.

7. The method of claim 1, wherein the WUR configuration identifies WUR Active time starting time.

8. The method of claim 1, wherein the WUR cycle is determined based on latency identified based on said information.

9. The method of claim 1, comprising:
transmitting an indicator identifying disabling of use of PO-based discontinuous reception (DRV) monitoring of WUS in non-connected mode.

10. The method of claim 1, comprising:
configuring a time window, usable for a communication action between the network node and the UE responsive to transmitting a WUS intended for the UE in a WUR Active time, wherein a starting time of the time window is configured based on the WUR Active time.

11. The method of claim 10, wherein configuring the time window comprises configuring a time window starting time based on the WUR configuration, said time window having a starting time offset after the WUR Active time.

12. The method of claim 11, wherein the starting time offset is configured based on a transition time for activating a main receiver of the UE.

13. The method of claim 1, comprising:
configuring the UE with a discontinuous reception (DRX) configuration for non-connected mode, identifying a DRX cycle of PO-based DRX Active times,
wherein the WUR cycle is 1/K times the DRX cycle, K being an integer 2:1.

14. A method carried out in a network node of a cellular radio network for configuring a User Equipment (UE) to monitor wake-up signal (WUS) reception in non-connected mode, wherein the method comprises:
obtaining information related to the UE, said information being indicative of a wake-up receiver (WUR) being comprised in the UE, and indicative of associated
timing performance of the WUR;
configuring the UE with:
a discontinuous reception (DRX) configuration for non-connected mode, identifying a DRX cycle of PO-based DRX Active times, and
WUR configuration, based on the obtained information, said WUR configuration identifying resources for monitoring WUS reception at WUR Active times repeated with a WUR cycle,
wherein the WUR cycle is 1/K times the DRX cycle, K being an integer 2:1.

15. The method of claim 14, wherein K>1.

16. The method of claim 14, wherein the WUR configuration identifies time correlation between the WUR Active times of the WUR cycle and DRX Active times of the DRX cycle.

17. The method of claim 16, wherein the time correlation is configured such that each WUR Active time precedes a next DRX Active time by a period at least meeting a required transition time for activating a main receiver of the UE.

18. A network node of a radio network, comprising:
a radio transceiver, and
logic circuitry, configured to control the radio node to carry out the steps of claim 14.

19. A method carried out in a User Equipment (UE) to obtain configuration for monitoring a wake-up signal (WUS) from a network node of a radio network, wherein the method comprises:
transmitting, to the radio network, information indicative of a wake-up receiver (WUR) being comprised in the UE, and indicative of associated timing performance of the WUR;
obtaining, from the radio network, WUR configuration, determined dependent on the transmitted information, said WUR configuration identifying resources for monitoring WUS reception at WUR Active times repeated with a WUR cycle.

20. The method of claim 19, wherein the WUR cycle is shorter than a discontinuous reception (DRX) cycle configurable by the network node for the UE.

21-33. (canceled)
